(19) United States
(12) Patent Application Publication
(10) Pub. No.: US 2007/0200056 A1
(43) Pub. Date: Aug. 30, 2007

(54) ANTI-REFLECTION COATED IMAGE SENSOR AND MANUFACTURING METHOD THEREOF

(76) Inventors: Bum-suk Kim, Seoul (KR); Getman Alexander, Yongin-si (KR); Yun-ho Jang, Seoul (KR); Sae-young Kim, Seoul (KR); Jong-jin Lee, Seoul (KR); Yo-han Sun, Suwon-si (KR); Keun-chan Yuk, Seoul (KR)

Correspondence Address: F. CHAU & ASSOCIATES, LLC, 130 WOODBURY ROAD, WOODBURY, NY, 11797, US

(21) Appl. No.: 11/627,744

(22) Filed: Jan. 26, 2007

(30) Foreign Application Priority Data
Feb. 28, 2006 (KR) 10-2006-0019341

(51) Int. Cl. H01J 3/14

(52) U.S. Cl. 250/216; 250/214.1

(57) ABSTRACT

An image sensor coated with an anti-reflection material having a microlens provided on a semiconductor substrate, the microlens corresponding to a light receiving device formed in the semiconductor substrate wherein the image sensor includes a first layer coated on a surface of the microlens, and a second layer coated on the first layer, wherein the second layer has a smaller refractive index than the first layer.

### CROSS-REFERENCE TO RELATED PATENT APPLICATION

This application claims priority to Korean Patent Application No. 10-2006-0019341, filed on Feb. 28, 2006 the disclosure of which is incorporated herein in its entirety by reference.

### BACKGROUND OF THE INVENTION

1. Technical Field

The present disclosure relates to an image sensor, and more particularly, to an image sensor coated with an anti-reflection material and a manufacturing method thereof.

2. Discussion of the Related Art

FIG. 1A is a schematic view of a conventional image sensor which has a dead zone.

Referring to FIG. 1A, an image sensor 10 includes a microlens 11 provided on a semiconductor substrate 12. The microlens 11 corresponds to a light receiving device formed in the semiconductor substrate 12. The microlens 11 comprises a thermosetting resin which is heated and mounted in a dome shape.

Boundary reflectance of the microlens 11 is about 5%. The image sensor 10 which includes the microlens 11 has a dead zone dz. Light incident on the dead zone dz cannot be received by the microlens 11. Therefore, sensitivity of the image sensor 10 is reduced as the image sensor 10 senses light incident on the microlens 11 but cannot sense light incident on the dead zone dz.

FIG. 1B is a schematic view of a conventional image sensor which has a dead zone removed by having a first layer coated on the image sensor 10.

Referring to FIG. 1B, the image sensor 20 includes a first layer 21 which comprises an oxide and is coated on a surface of the microlens 11 to remove the dead zone dz of the conventional image sensor 10 of FIG. 1A. A thickness of the first layer 21 coated on the microlens 11 may change. The dead zone dz illustrated in FIG. 1A is removed from the image sensor 20 by coating the first layer 21 on the microlens 11 to cover the microlens 11.

The first layer 21 comprises an oxide which has a refractive index of 1.47. Therefore, although coating the first layer 21 in the conventional image sensors 20 removes the dead zone dz, transmission efficiency of the conventional image sensor 20, which is required to be as high as possible for high sensitivity image sensing, can be affected.

### SUMMARY OF THE INVENTION

According to an exemplary embodiment of the present invention, an image sensor coated with an anti-reflection material has a microlens provided on a semiconductor substrate, wherein the microlens corresponds to a light receiving device formed in the semiconductor substrate. The image sensor may include a first layer coated on a surface of the microlens, and a second layer coated on the first layer, wherein the second layer has a smaller refractive index than the first layer. A sum of thicknesses of the first layer and the second layer may be sufficient to remove a dead zone of the microlens.

The first layer may be formed of an oxide. The first layer may be coated to a thickness that minimizes reflectance of light incident on the microlens. The first layer may have a thickness of about 8,000 Å.

The second layer may be formed of MgF₂. The second layer may be coated to a thickness minimizing reflectance of light incident on the microlens. The second layer may have a thickness of about 900 Å.

The first layer may be formed of an oxide, and the second layer may be formed of MgF₂. The first layer may be coated to a thickness of about 8,000 Å and the second layer may be coated to a thickness of about 900 Å.

According to an exemplary embodiment of the present invention, a method of manufacturing an image sensor coated with an anti-reflection material has a microlens provided on a semiconductor substrate, wherein the microlens corresponds to a light receiving device formed in the semiconductor substrate. The method may include coating a first layer on a surface of the microlens, and coating a second layer on the first layer. The second layer may have a smaller refractive index than the first layer.

A sum of thicknesses of the first layer and the second layer may be sufficient to remove a dead zone of the microlens.

The first layer may be formed of an oxide. The first layer may be coated to a thickness that minimizes reflectance of the microlens for light incident thereto. The first layer may have a thickness of about 8,000 Å.

The second layer may be formed of MgF₂. The second layer may be coated to a thickness minimizing reflectance of the microlens for light incident thereto. The second layer may have a thickness of about 900 Å.

The first layer may be formed of an oxide, and the second layer may be formed of MgF₂. The first layer may be coated to a thickness of about 8,000 Å and the second layer may be coated to a thickness of about 900 Å.

### BRIEF DESCRIPTION OF THE DRAWINGS

Exemplary embodiments of the present invention can be understood in more detail from the following description taken in conjunction with the accompanying drawings in which:

FIG. 1A is a schematic view of a conventional image sensor which has a dead zone;

FIG. 1B is a schematic view of a conventional image sensor which has a dead zone removed by having a first layer coated on the conventional image sensor shown in FIG. 1A;

FIG. 2 is a schematic view of an image sensor coated with an anti-reflection material according to an exemplary embodiment of the present invention;

FIG. 3 is a graph illustrating light transmittance versus thickness of a second layer coated on the image sensor illustrated in FIG. 2;

FIG. 4 is a graph illustrating simulation results for transmittance of light incident on the image sensor illustrated in FIG. 2; and

FIG. 5 is a flowchart illustrating a method of manufacturing an image sensor coated with an anti-reflection material according to an exemplary embodiment of the present invention.

### DETAILED DESCRIPTION OF EXEMPLARY EMBODIMENTS

Exemplary embodiment of the present invention will be described below in more detail with reference to the accompanying drawings. The present invention may be embodied in many different forms and should not be construed as limited to the embodiments set forth herein.

FIG. 2 is a schematic view of an image sensor coated with an anti-reflection material according to an exemplary embodiment of the present invention.

Referring to FIG. 2, an image sensor 100 includes a microlens 110 provided on a semiconductor substrate 120. The microlens 110 corresponds to light receiving device (not shown) formed in the semiconductor substrate 120. A first layer 130 is coated on a surface of the microlens 110. In an exemplary embodiment of the present invention, the microlens 110 comprises a thermosetting resin, and is heated and mounted on the semiconductor substrate 120.

The first layer 130 comprises an oxide and is coated on a surface of the image sensor 100 covering the microlens 110 to remove a dead zone dz of the image sensor 100.

A second layer 140 is coated on the first layer 130. The second layer 140 has a lower refractive index than the first layer 130. For example, the first layer 130, comprising, for example, an oxide, has a refractive index of about 1.47, and the second layer 140 has a lower refractive index than the first layer 130.

The first layer 130 removes the dead zone dz by covering the dead zone dz of the microlens 110 but has a high refractive index, so that the transmittance of incident tight passing the first layer 130 does not improve substantially. Therefore, the second layer 140 is coated on the first layer 130 to improve transmittance of light incident on the image sensor 100 while also removing the dead zone dz of the image sensor 100.

According to an exemplary embodiment of the present invention, the second layer 140 may comprise, for example, MgF₂ having a refractive index of 1.37. The first and second layers 130 and 140 are coated such that a sum of thicknesses of these layers 130 and 140 is sufficient to remove the dead zone dz of the image sensor 100. The first and second layers 130 and 140 are coated such that reflectance of tight incident on the microlens 110 is minimized.

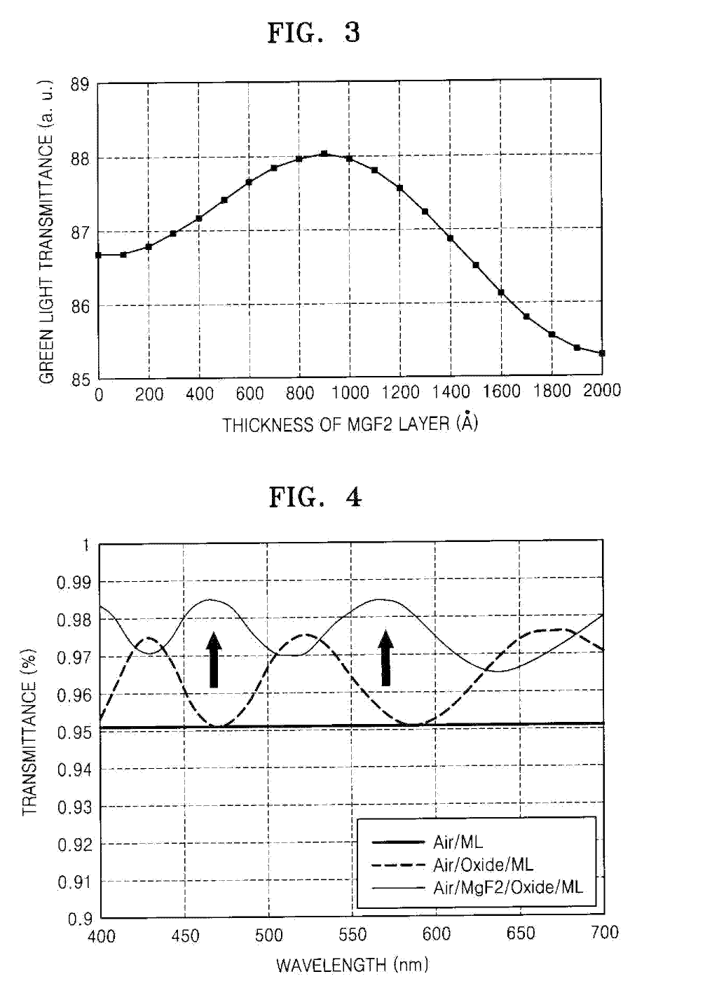

FIG. 3 is a graph illustrating light transmittance versus a thickness of a second layer, comprising MgF₂, coated on the microlens 110 as illustrated in FIG. 2.

Referring to FIGS. 2 and 3, the image sensor 100 has different transmittance of incident light depending on the thickness of the second layer 140. Transmittance of incident light is maximized when the second layer 140 has a thickness of about 900 Å and the transmittance of incident light is significantly reduced when the second layer 140 has a thickness greater than 900 Å.

FIG. 4 is a graph illustrating simulation results of transmittance of light incident on the image sensor 100 illustrated in FIG. 2.

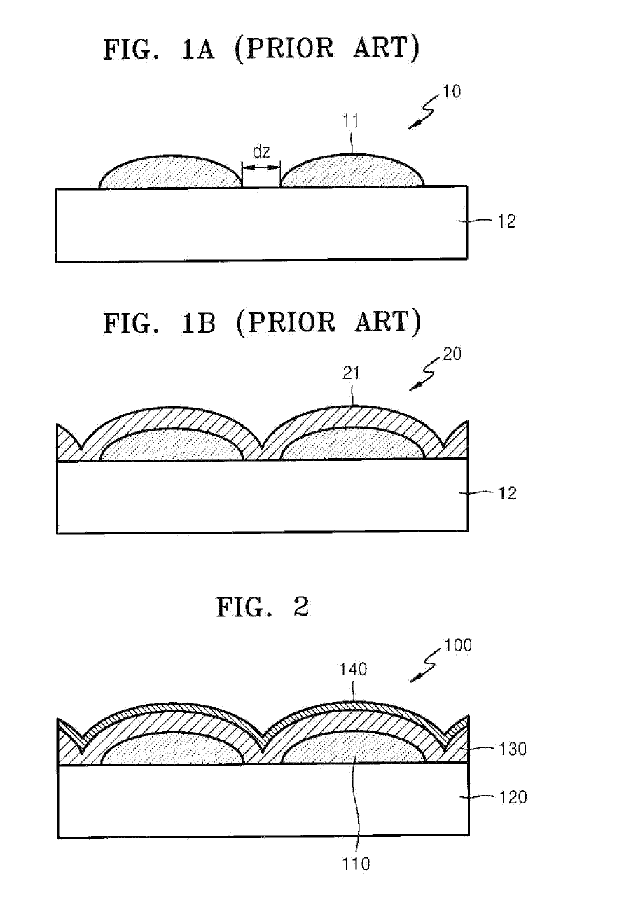

FIG. 4 is a graph illustrating transmittance of tight incident on the image sensor 100 (solid line) when the first layer 130 has a thickness of 8,000 Å and the second layer 140 has a thickness of 900 Å. The image sensor 100 according to an exemplary embodiment of the present invention has improved transmittance when the first layer 130 has a thickness of 8.000 Å and the second layer 140 has a thickness of 900 Å, compared to the transmittance of light incident on the conventional image sensor 20 (dotted line) illustrated in FIG. 1B which has only a first layer 21.

Since boundary reflectance of the microlens 110 for incident light is about 0.95, the image sensor 100 having the first layer 130 having a thickness of 8,000 Å and the second layer 140 having a thickness of 900 Å reduces reflectance of the microlens by more than 50%. Therefore, the image sensor 100 having the second layer 140 comprising, for example, MgF2 increases transmittance thereof by more than 3% when compared to the conventional image sensor 20 illustrated in FIG. 1B.

Referring to FIG. 2, the image sensor 100 does not include the dead zone dz of the conventional image sensor 10 illustrated in FIG. 1A and has improved transmittance of incident light compared to the image sensor 20 illustrated in FIG. 1B.

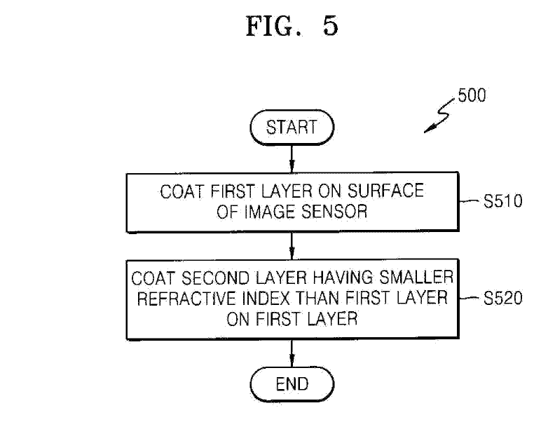

FIG. 5 is a flowchart illustrating a method of manufacturing an image sensor coated with an anti-reflection material according to an exemplary embodiment of the present invention.

FIG. 5 illustrates a method of manufacturing an image sensor coated with an anti-reflection material having a microlens provided on a semiconductor substrate. The microlens corresponds to a light receiving device formed in the semiconductor substrate.

The method 500 includes coating a first layer on a surface of the image sensor covering the microlens (S510) and coating a second layer on the first layer (S520).

The second layer has a smaller refractive index than the first layer. The first layer may comprise an oxide, and the second layer may comprise MgF₂.

In an exemplary embodiment of the present invention, an image sensor coated with an anti-reflection material and a manufacturing method thereof can remove a dead zone of the image sensor and can increase transmittance of light incident on the image sensor coated with the anti-reflection material.

In an exemplary embodiment of the present invention, the image sensor coated with an anti-reflection material and manufacturing method thereof can reduce boundary reflectance of a microlens by more than 50% by coating a first layer comprising, for example, an oxide to a thickness of about 8,000 Å, and coating a second layer comprising, for example, MgF2 to a thickness of about 900 Å on the first layer comprising oxide. Therefore, the image sensor coated with an anti-reflection material and manufacturing method thereof according to an exemplary embodiment of the present invention can increase pixel sensitivity by more than 3% when compared to a conventional image sensor.

Although exemplary embodiments have been described with reference to the accompanying drawings, it is to be understood that the present invention is not limited to these precise embodiments but various changes and modifications can be made by one skilled in the art without departing from the spirit and scope of the present invention. All such changes and modifications are intended to be included within the scope of the invention as defined by the appended claims.

What is claimed is:

1. An image sensor coated with an anti-reflection material having a microlens provided on a semiconductor substrate, the microlens corresponding to a light receiving device formed in the semiconductor substrate, the image sensor comprising:
a first layer coated on a surface of the microlens; and
a second layer coated on the first layer, wherein the second layer has a smaller refractive index than the first layer.

2. The image sensor of claim 1, wherein a sum of thicknesses of the first layer and the second layer is sufficient to remove a dead zone of the microlens.

3. The image sensor of claim 2, wherein the first layer comprises an oxide.

4. The image sensor of claim 3, wherein the first layer is coated to a thickness that minimizes reflectance of light incident on the microlens.

5. The image sensor of claim 4, wherein the first layer has a thickness of about 8,000 Å.

6. The image sensor of claim 2, wherein the second layer comprises MgF₂.

7. The image sensor of claim 6, wherein the second layer is coated to a thickness to minimize reflectance of light incident on the microlens.

8. The image sensor of claim 7, wherein the second layer has a thickness of about 900 Å.

9. The image sensor of claim 2, wherein the first layer comprises an oxide, and the second layer comprises MgF₂.

10. The image sensor of claim 9, wherein the first layer is coated to a thickness of about 8,000 Å and the second layer is coated to a thickness of about 900 Å.

11. A method of manufacturing an anti-reflection coated image sensor having a microlens provided on a semiconductor substrate, the microlens corresponding to a light receiving device formed in the semiconductor substrate, the method comprising:
coating a first layer on a surface of the microlens; and
coating a second layer on the first layer, wherein the second layer has a smaller refractive index than the first layer.

12. The method of claim 11, wherein a sum of thicknesses of the first layer and the second layer is sufficient to remove a dead zone of the microlens.

13. The method of claim 12, wherein the first layer comprises an oxide.

14. The method of claim 13, wherein the first layer is coated to a thickness that minimizes reflectance of light incident on the microlens.

15. The method of claim 14, wherein the first layer has a thickness of about 8,000 Å.

16. The method of claim 12, wherein the second layer comprises MgF₂.

17. The method of claim 16, wherein the second layer is coated to a thickness that minimizes reflectance of light incident on the microlens.

18. The method of claim 17, wherein the second layer has a thickness of about 900 Å.

19. The method of claim 12, wherein the first layer comprises an oxide, and the second layer comprises MgF₂.

20. The method of claim 19, wherein the first layer is coated to a thickness of about 8,000 Å and the second layer is coated to a thickness of about 900 Å.
